(19) United States
(12) Patent Application Publication
(10) Pub. No.: US 2010/0035220 A1
(43) Pub. Date: Feb. 11, 2010

(54) ON-LINE STUDENT SAFETY LEARNING AND EVALUATION SYSTEM

(76) Inventors: Frederick S.M. Herz, Milton, WV (US); Adena E. Harvey, Milton, WV (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/501,113

(22) Filed: Jul. 10, 2009

Related U.S. Application Data
(60) Provisional application No. 61/079,557, filed on Jul. 10, 2008.

(51) Int. Cl. G09B 19/00; G09B 7/00

(52) U.S. Cl. 434/236; 434/350; 434/362

(57) ABSTRACT

A system and method for providing educational content and testing over the internet in order to teach students (e.g., college students) safe, responsible attitudes, values, and behaviors that will lower incidents leading to liability, and hence lower liability insurance for entities, including schools, attended by such students. Software modules provide the educational materials and testing materials as well as data mining techniques to determine which member attributes of that entity, or groups of member attributes, are statistically likely to be at risk for a liability situation or are in danger of harmful activity. The data mining combined with statistical analysis also enables the entity to ensure that students with certain attributes receive customized content addressed to the student's particular issues and provides for follow-up to verify that the students indeed learn the customized content. For example, the learning materials may relate to student safety and/or sociological and/or psychometric risk factors of the students.

### CROSS-REFERENCE TO RELATED APPLICATIONS

The present application claims priority to U.S. Provisional Patent Application No. 61/079,557, filed Jul. 10, 2008. The contents of that patent application are hereby incorporated by reference in their entirety.

### FIELD OF THE INVENTION

The invention relates to an on-line safety learning and evaluation system for use by educational institutions, local community emergency services, and other public and private organizations to identify safety risk factors in the student and/or general population so that the risks may be addressed through safety training and intervention.

### BACKGROUND OF THE INVENTION

The news is replete with stories of campus shootings, student alcohol binges, and student violence, as well as other antisocial and harmful behavior of members of the general population. Educational and other institutions are struggling with how to maintain security and a safe environment while preventing the imposition of a police state. Educational institutions have acute issues in this regard as they are held directly accountable for the safety of their students yet require an open and accessible academic environment to foster learning. Also, the options available to educational and other institutions to avoid significant liability from the actions of students and other individuals are significantly limited by privacy concerns for the individuals, particularly in the case of students. It has become increasingly difficult for educational and other institutions to balance safety needs with such privacy interests.

It is well known by psychologists that certain psychological profiles correlate with aberrant behavior. It is also well-known that certain groups' or individuals' attributes correlate more highly than others with certain anti-social or harmful behaviors. Present day society frowns upon targeting individuals using profiling; however, profiling remains a useful way for law enforcement authorities to identify those individuals most likely to put others at risk. It is particularly desirable to find a way to identify persons or students that are most likely to harm themselves or others without infringing upon the civil liberties of such persons. One way to do this is to correlate behaviors with individual's attributes without necessarily identifying which specific individuals have those particular attributes. In other words, those attributes that correlate with undesirable behavior may be identified without violating an individual's privacy and without identifying a particular individual with such attributes.

Once particular undesirable behavior is identified and correlated with certain attributes, the next difficult task is to educate individuals to avoid such behavior without stigmatizing those individuals or otherwise suggesting that they fall into an at-risk group, for to do so may hinder the ability to educate such individuals. One useful way to reach individuals to educate them about certain harmful behaviors is through use of an e-learning platform. Such platforms are prevalent today for providing and managing exercises and tests and to provide personalized navigation of individuals through the available collections of exercises and tests. Some such e-learning platforms (e.g., Le Vin-Qam platform) take into account the user's profile (level of skills) and history and analyzes the user's answers and stores same to facilitate data mining of the answers. However, to date, such platforms have not been adapted to address issues of student safety or for evaluating individuals based on their attributes to enable an educational system to target the appropriate learning content to the individual based on their identified needs or propensities based on their attributes. The present invention addresses these and other short-comings in the prior art.

### SUMMARY OF THE INVENTION

The invention relates to a system and method for providing educational content and testing over the internet in order to teach students (e.g., college students) safe, responsible attitudes, values, and behaviors that will lower incidents leading to liability, and hence lower liability insurance for entities, including schools, attended by such students. The invention includes software modules that are implemented by the entity to implement to provide the educational materials and testing materials as well as data mining techniques to determine which members of that entity, or groups of members, are statistically likely to be at risk for a liability situation or are in danger of harmful activity. Data mining combined with statistical analysis also enables the entity to ensure that the students receive customized content addressed to the student's particular issues and provides for follow-up to verify that the students indeed learn the customized content. For example, a software system may be used to pull the needed information from a database and to provide the information to a student or group of students in the form of customized training and testing to ensure that the individual or group has enhanced performance and understanding of the described content. By way of example, one such approach incorporates a variety of alternative methodologies to teaching and training and also engages other members of that entity and groups through social networks.

The methods of the invention may be implemented in a verbal environment in which humans, situations, and even groups can be recruited to assist the individual and vice-versa using a variety of types of simulation algorithms to simulate the substantial variety of situations of imminent emergencies and non-emergencies and the various social interactions that would normally accompany those situations. Reward points may be given to students, as well as credit, for each portion of the educational content and testing that is successfully passed.

A preferred approach to ensuring proper skills are developed to meet the particular risk of incidents or liability situations includes implementing a probability algorithm (predictive data mining) to assess the likelihood of various types of incidents or chronic or imminent harm to members of the entity in order to provide feedback to the system to ensure the highest degree of accuracy is provided to deliver effective content, simulation situations, and/or social network mediated interactions that will most benefit an entity member or group at risk as well as leverage their potential to assist other entity members through the most optimal means possible.

### BRIEF DESCRIPTION OF THE DRAWINGS

FIG. 1 illustrates a Safety Training and Preparedness System and Statistical Analysis System implemented on a server in accordance with an embodiment of the invention.

FIG. 2 illustrates the system flow for providing the initial user input into the Safety Training and Preparedness System.

FIG. 3 illustrates the system flow for providing staff input into the Safety Training and Preparedness System.

FIG. 4 illustrates the basic system flow of the Safety Training and Preparedness System during use.

FIG. 5 illustrates the presentation of content to a user of the Safety Training and Preparedness system during use.

FIG. 6 illustrates the presentation of test questions to a user of the Safety Training and Preparedness system during use.

FIG. 7 illustrates a sample flow of the Statistical Analysis system during operation.

FIG. 8 illustrates a certificate generation process of the Safety Training and Preparedness System.

FIG. 9 illustrates the email notice process of the Safety Training and Preparedness System.

FIG. 10 illustrates the process for displaying color coded reports to contacts and supervisors.

FIG. 11 illustrates the Reports subroutine of the Safety Training and Preparedness System.

FIG. 12 illustrates sample content provided to students by the Safety Training and Preparedness System for increasing student awareness of alcoholism.

FIG. 13 illustrates a sample test question related to the material presented in FIG. 12.

FIG. 14 illustrates a sample certificate that may be issued if a student successfully passes the test by correctly answering a predetermined percentage of test questions.

FIG. 15 illustrates sample emails that may be forwarded to the student's counselor, coach, and coach's supervisor in the event that the student does not pass the test.

FIG. 16 illustrates a sample graphical user interface that may be presented to a staff member or supervisor to enable him/her to determine at a glance which cross-sections of the students need the most remedial help for particular safety issues.

### DETAILED DESCRIPTION OF ILLUSTRATIVE EMBODIMENTS

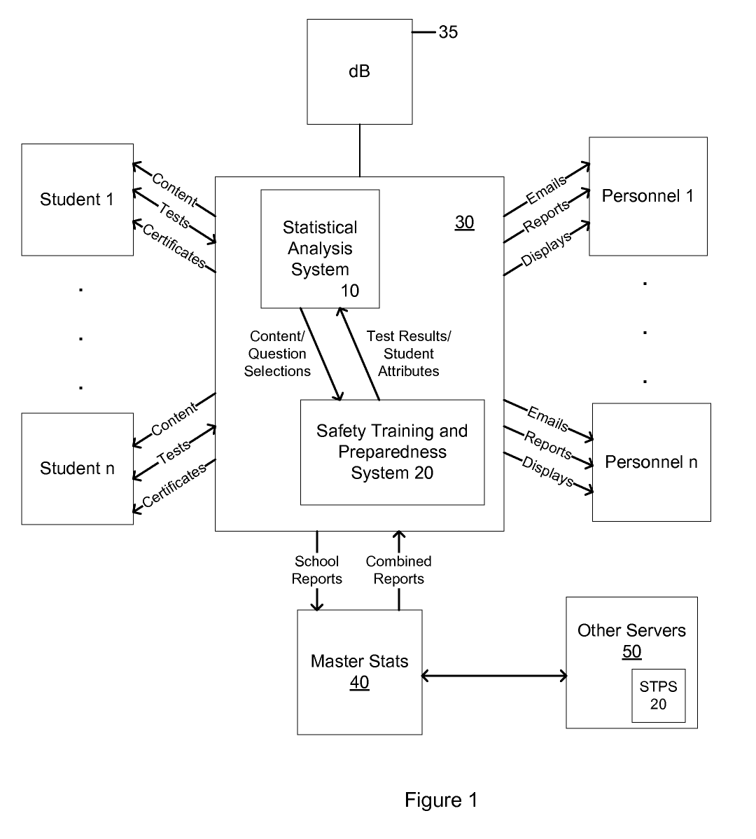

Preferred embodiments of the invention will be described in detail below with reference to FIGS. 1-16. Those skilled in the art will appreciate that the description given herein with respect to those figures is for exemplary purposes only and is not intended in any way to limit the scope of the invention. All questions regarding the scope of the invention may be resolved by referring to the appended claims.

### System Overview

The system and method described herein provides a mechanism for presenting educational content to students in an e-learning environment so as to promote safe, responsible attitudes, values, and behaviors that will lower incidents, liability, and liability insurance for entities, such as schools and universities, that implement the system and method described herein. The system and method allows the entity to use data mining techniques to identify which student attributes or group of student attributes statistically correlate with particular behavior that may result in liability or harm to a student or the student's peers and environment. Statistical analysis permits the system to match certain indicators with certain learning materials that target certain student attributes or group of student attributes. In other words, the content is steered to where it is needed the most. Assuming privacy concerns are properly balanced, the system and method also may be adapted to alert appropriate staff and contacts for the person that he/she is at risk of imminent harm to himself/herself or others.

As illustrated in FIG. 1, a statistical analysis system (SAS) 10 and Safety Training/Preparedness System 20 resides on a server 30 having associated database 35. The Safety Training/Preparedness System 20 sends content to the students that has been customized to ensure that the students understand the subject matter, provides performance evaluations to (tests) determine if the students have indeed understood the material, and provides certificates if the material has been successfully understood. The Safety Training/Preparedness System 20 also sends e-mails to personnel that are designated to be contacted by virtue of their relationship with the student. For example, if the student fails a training section or a portion thereof, the system 20 may produce a variety of reports that are forwarded to designated individuals for viewing. The system 20 may also send the results of the performance evaluations to the SAS 10 for a determination of what material is best suited to particular groups of students. These results are stored in the Safety Training/Preparedness System 20 and sent on, for example, a semesterly basis to Master Stats server 40 that may combine all statistical data from all schools having servers 50 operating the Safety Training/Preparedness System 20 of the invention. Master Stats server 40 is preferably equipped with data mining software for mining the student data received from the respective schools to determine relationships in the data that are useful for modifying the content and the tests.

Safety Training/Preparedness System 20 is an e-learning system that is accessed by students for learning content, participating in performance evaluations, and in receiving certificates evidencing that certain milestones have been reached. The system 20 receives the students' test results. The content provided to the students and the performance evaluation questions are determined by the interaction between the system 20 and SAS 10. SAS 10 receives the test results for each student as well as student attributes and evaluates this information to identify any correlations between attributes and performance for a particular student as well as for all other students at the school that have reviewed that particular learning content and taken that test to determine which content available for that subject is best understood by that specific group of students. The SAS 10 updates the content/question selection for the group of students that share the attribute that is the determining factor for that learning content. The SAS 10 also may adjust the questions presented for particular content based on the user attributes and performance on previous test questions.

The Safety Training/Preparedness System 20 sends e-mail notices to staff personnel that have the most direct contact with the students if the student fails a test or a portion thereof or a class. An e-mail also may be sent to the direct staff's supervisor(s), and reports are provided to such persons for viewing on-screen or for printing. The student data may be broken down for a particular student and reports also may be generated relating to all students for which a particular staff member is responsible. At regular intervals (e.g., the end of every semester), the system 20 may provide a batch report of classes taken, attributes of students, passing rates, and content/question determinations for specific groups of students. The system 20 also may receive periodic reports from Master Stats server 40 where the data from different schools has been combined for more comprehensive analysis and understanding.

As noted above, the Safety Training/Preparedness System 20 sends learning content to students and provides performance evaluations (tests) to the students that are based on learning content provided to the students. Once the responses to the performance evaluations have been returned by the students, the responses are sent to the Statistical Analysis System(SAS) 10 for a determination of the best content/questions for specific groups of students based on the attributes that most affect their scores in order to ensure that the students understand the learning topic covered by the performance evaluation. If the student passes the course, a certificate is printed and forwarded to the student. However, if the student fails the course, an e-mail is sent to school personnel who have direct contact with the student and another e-mail is sent to the supervisor of those personnel to notify him/her that the student for whom his/her subordinate is responsible has received an e-mail notice of a failing student. School personnel can receive color coded displayed reports or written reports broken down in various ways. The Master Statistics System 40 further receives a report at periodic intervals (e.g. every semester) aggregating the results of what content/questions are best for what students. The Master Statistics System 40 will send back aggregated data for all schools that have the system in order to better customize the content.

In an exemplary embodiment, the system of FIG. 1 may be implemented on a cluster of servers with shared storage and a shared database. One of the servers may be specified to run the application described herein as well as a web server. Appropriate configurations will be apparent to those skilled in the art.

### First Time User Inputs

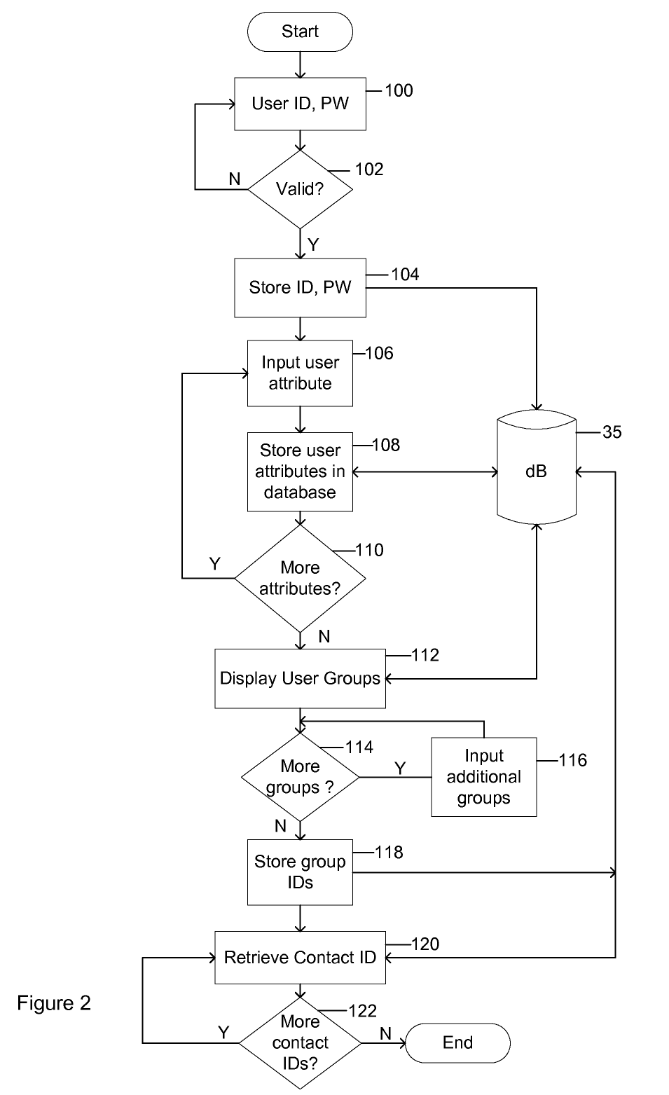

FIG. 2 illustrates the system flow for providing the initial user input into the Safety Training and Preparedness System 20. As illustrated, the system 20 accepts the user his/her user ID and password (PW) at step 100. At step 102, system 20 determines if anyone else has that user ID and that the password is valid. If the ID is taken or the password is invalid, control returns to step 100. Otherwise, system 20 proceeds to step 104 for storage of the user ID, password, and, optionally, the user name. Next, at step 106, system 20 accepts user attribute data. Such data may include the user's sex, race, ethnicity, home town, zip code, address, personal attributes, date of birth, sports teams, school clubs, major, class schedule, class performance data, GPA, groups and affiliations, and other activities participated in by the student (e.g., fraternities and sororities). At step 107, the attributes are checked to see if they are valid. At step 108, user attributes are stored with the user ID in an attribute table of database 35. At step 110, the system 20 determines if there are any more user attributes. If so, control returns to step 106; otherwise, the system 20 proceeds to step 112 where the groups of which the student is a member are displayed on a display device. In particular, the system 20 retrieves the group IDs from database 35 and displays them on a display device (not shown). The system 20 then asks the user at step 114 if there are any more groups and, if so, control proceeds to step 116 to allow the user to input additional group data. Once all of the user group data has been input, at step 118 the system 20 stores the group IDs with the user ID in a table of database 35. Once all of the group IDs have been entered, at step 120 the system 20 retrieves the contact ID for a group (e.g., faculty sponsor for that group) from a table of database 35 and writes the contact ID to a table with the user ID. Then the system 20 determines at step 122 whether there are there any other contact IDs and, if so, control returns to step 120. If there are no more contact IDs, the user input process ends. This input process is performed by each student that is to use the system 20.

The system 20 may also permit the users to specify their majors, as appropriate. This enables users to be grouped by major.

### Staff Input

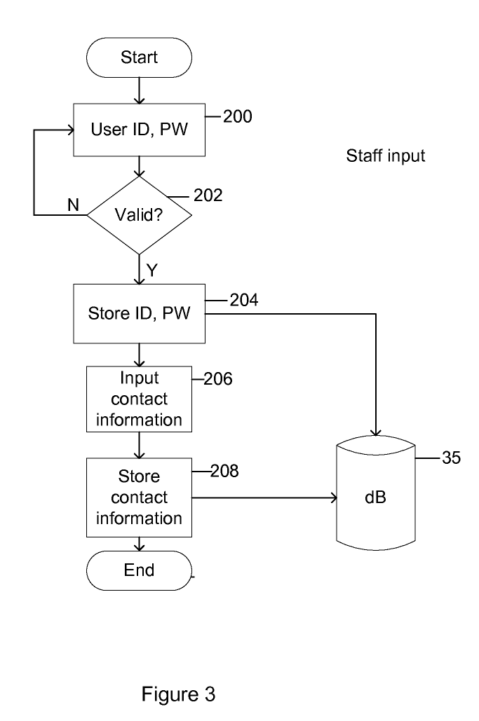

As illustrated in FIG. 3, at step 200, the Safety Training/Preparedness System 20 accepts the user ID and password for a staff member for accessing the system 20. If it is determined at step 202 that the user ID and password are not valid (e.g., someone else has that user name or the PW is invalid), control returns to step 200. Otherwise, control proceeds to step 204 for storage of the user ID and password, and optionally the user name, in a table of database 35. At step 206, the user provides his/her email address and any other contact information for storage in the appropriate table of database 35 at step 208. The process then ends but may be repeated for each staff member that is to use system 20

### User System Interaction

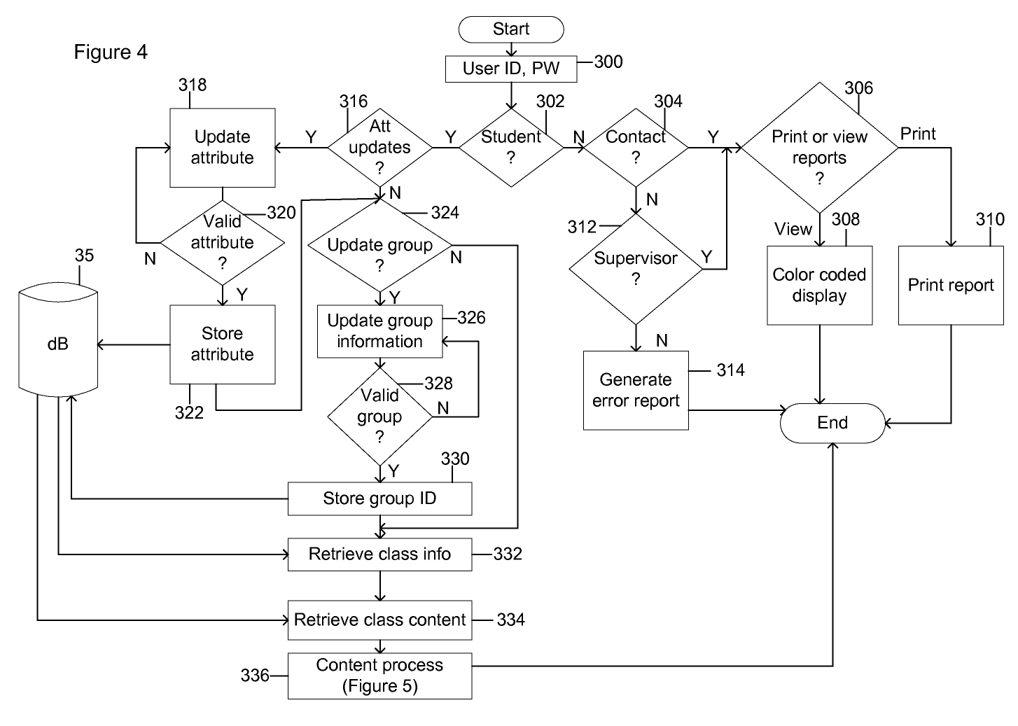

As illustrated in FIG. 4, during access of system 20 by a user, at step 300, the Safety Training/Preparedness System 20 accepts the user ID and password and determines at step 302 whether the user is a student. If not, the system 20 proceeds to step 304 to determine if the user is a contact. If the user is a contact, the system proceeds to step 306 to determine if the user wants to print or view reports. If the user wants to view reports, control proceeds to step 308 for viewing a color coded display. If the user wishes to print a report, control instead proceeds to step 310 for printing of a report. If the user is not a contact or a student, control proceeds to step 312 to determine if the user is a supervisor. If so, control proceeds to step 306 to view or print a report. If not, control proceeds to step 314 to generate an error report and processing ends.

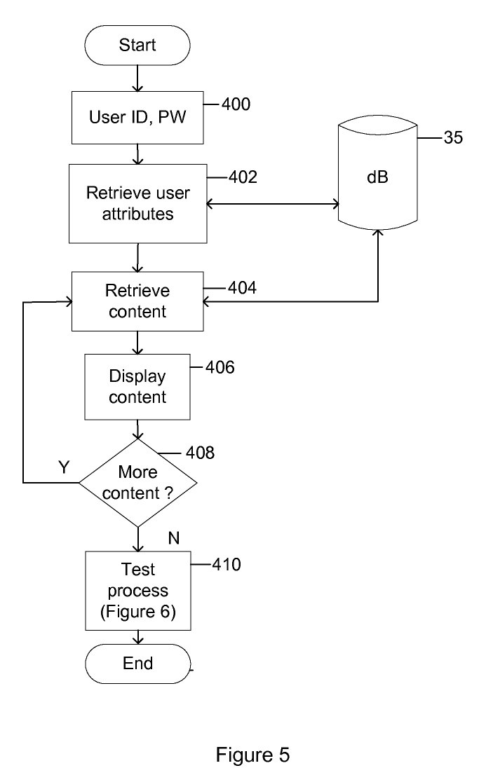

However, if it is determined at step 302 that the user is a student, control proceeds to step 316 to determine if there are any updates needed to attributes, groups, majors, etc. If there is an update needed to an attribute, the system 20 accept user input of the updated attribute at step 318. At step 320, the system 20 checks if the attribute is valid. If so, the system 20 stores the attribute ID with the user ID in a table of database 35 at step 322. Otherwise, system 20 returns to step 318. Once the attribute is stored in database 35, or if it is determined at step 316 that no attribute updates are needed, control proceeds to step 324 to determine if a group needs to be updated. If so, the user updates the group information at step 326 and, at step 328, the validity of the group is checked. If the group information is not valid, control returns to step 326; otherwise, control proceeds to step 330 for storage of the updated group ID with the user ID in a table of database 35. Once the updated group ID is stored, or if it is determined at step 324 that no group is to be updated, control proceeds to step 332. At step 332, the system 20 retrieves the class information for that student from a table in database 35 and retrieves the appropriate content for that class at step 334. As noted above, SAS 10 preferably has previously determined the best content for that class to ensure that the user understands the content by checking for the choices of content available for that class. Thus, at step 334, the system 20 retrieves the attributes for that student and determines the correct content for that attribute set, which is retrieved. Control then proceeds to the Content subprocess at step 336 (FIG. 5), after which the process ends.

### Content Process

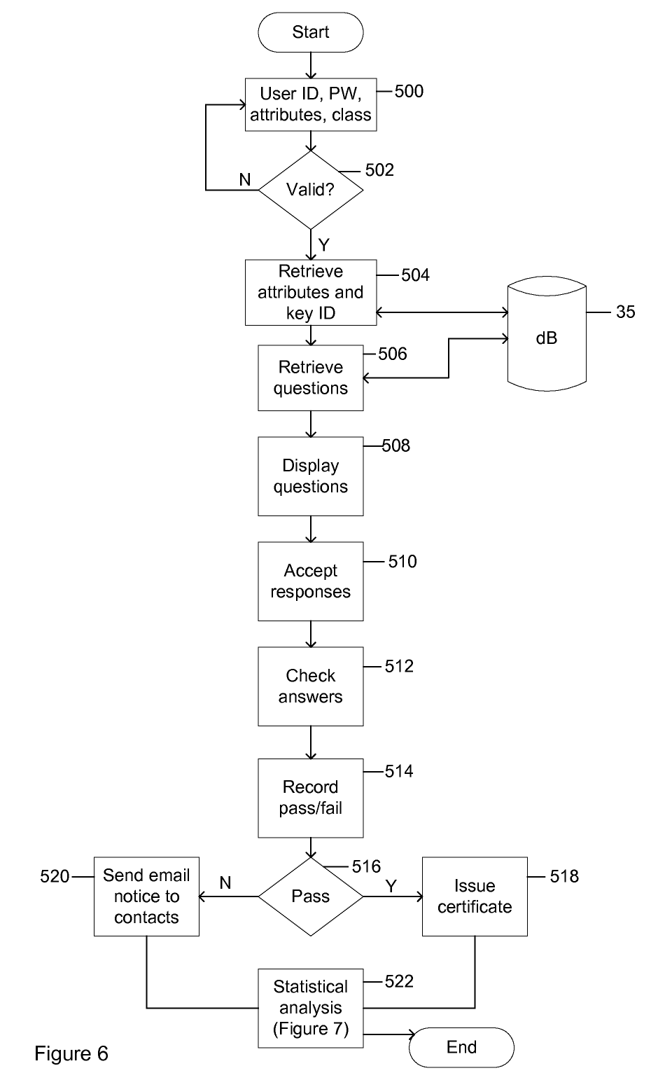

As illustrated in FIG. 5, the system 20 retrieves content by first accepting the user ID and password from the user at step 400 and then retrieving the user's attributes from database 35 at step 402. At step 402, the system 20 retrieves the correct content for the user by retrieving the correct key ID for that user from the database 35 and the choices of content for that user from a table in the database 35. The key ID is a computer generated variable that is placed with the class ID to indicate the content options available to that user. The SAS 10 determines which of the available content is best for each particular student based on the user's attributes, and the system 20 retrieves the correct content ID for the particular content for that user from a table in the database 35 at step 404. The content is retrieved using the content ID, and in step 406, the retrieved content is displayed for the user to review. After the user has reviewed that content, the system 20 proceeds to step 408 to determine if there is any more content available for that class and that user. If more content is available to the user, the system 20 returns to step 404; otherwise, the system proceeds to the test process at step 410 (FIG. 6) before ending.

During operation, the system 20 retrieves what class/module the user is taking and the user's saved attributes. The system 20 finds what content is best for that set of user attributes retrieves the key ID for that content from the database 35. The system 20 then retrieves the corresponding content and displays it for the user. The system will repeat the retrieval of content, in a loop cycle, until there is no other content for that class and that user's attributes.

### Test Process

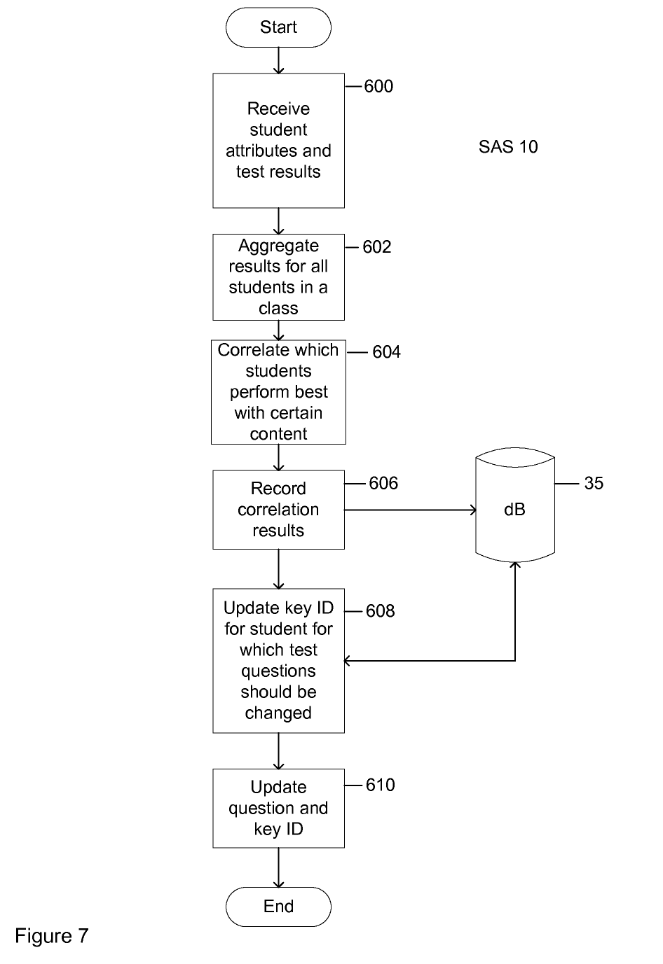

As illustrated in FIG. 6, at step 500 the system 20 accepts the user ID, attributes, class ID, and password. At step 502, the system 20 verifies the user ID and password and, if valid, the system 20 proceeds to step 504 where the student's attributes are retrieved from the database 35 along with the appropriate Key ID for each attribute (as determined by statistical analysis). Based on the attributes and Key IDs of same, question IDs are retrieved from database 35, and the question for that content is retrieved from the appropriate table in database 35 at step 506 and displayed at step 508. At step 510, the system 20 accepts an answer for the question presented to the user. At step 512, the answer is compared to the correct answer in a table of database 35, and at step 513, it is determined whether additional questions need to be answered for covering specific content for the specific group and/or specific user. If so, another question is retrieved at step 506. Otherwise, at step 514, the system 20 records the pass/fail for the question(s) for that student in a table of database 35. At step 516, it is determined whether the student passed and, if so, a certificate is issued to the student at step 518. To issue the certificate, the system 20 accepts from the test process the student ID and the class ID and retrieves the student's name from the database 35 for inclusion in the certificate. The student name is merged into the certificate for that class and the certificate is either emailed to the student or locally printed. On the other hand, if the student failed, an e-mail notice is forwarded to the designated student contacts at step 520. Statistical analysis is then performed at step 522 as described below with respect to FIG. 7.

### Statistical Analysis

As illustrated in FIG. 7, SAS 10 retrieves and compares the student attributes and test results from the Safety Training and Preparedness System 20 at step 600. At step 602, statistical analysis is performed by aggregating all students who have taken a particular class and statistically analyzing the results for each question based on which students with which set of attributes perform best with the specific content addressed by each question. Based on this analysis, SAS 10 determines at step 604 what content needs to be given to each student so that they might understand the content to the best of their ability by correlating the students' results with the content. At step 606, SAS 10 records the results from the statistical analysis in a table of database 35. Then, in step 608, SAS 10 retrieves the appropriate key ID from a table of the database 35 and determines whether the content needs to change for a specific group of students. If so, SAS 10 updates the key ID in the database 35 for those specific students. SAS 10 also determines at step 610 whether the question needs to change for that specific content. If so, SAS 10 determines the appropriate key ID for the content/question combination and updates same in an appropriate table of database 35. Finally, at step 612, the key code for the content ID is updated as appropriate.

SAS 10 thus receives the pass/fail status for each question/content by user attribute/performance and compiles this data with other user data and calculates which question/content is best for groups of user attribute/performance sets. The SAS 10 then updates the correct question/content for each group from an updating table and then finds all students with the same attribute ID and updates their question/content ID to the appropriate data. Groups can be defined by attributes, performance, or associated group memberships. The statistical analysis will send a report (or be otherwise accessed and analyzed directly) to the system administrator if overall student performance on a question or set of questions is below normal, if questions tend to receive overall low student scores which correspond to a specific content or if a particular attribute or group scores low with a particular question, or questions which correspond to a particular content. Questions/content can be re-evaluated at that point for effectiveness as well as correlation to effectiveness based upon attribute or group or question as used in this context can constitute a question set or even entire test.

### Certificate

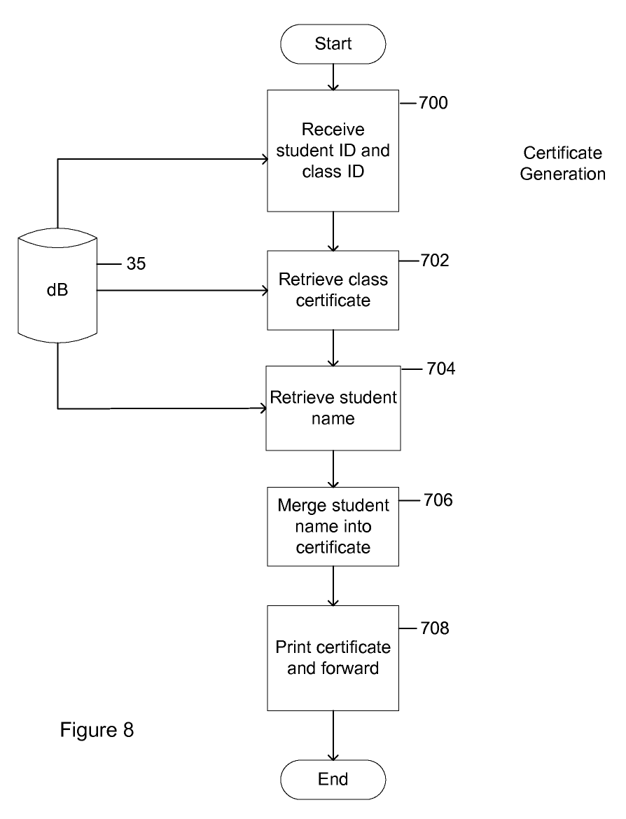

FIG. 8 illustrates a certificate generation process of the Safety Training and Preparedness System 20. At step 700, the system 20 accepts from the test subprocess the student ID and class ID. At step 702, the certificate for the class is retrieved from a table of database 35, and at step 704 the student's name is retrieved from a table of the database 35. At step 706, the system 20 merges the student's name onto the certificate for that class, and at step 708, the certificate is printed and forwarded to the student.

### E-mail Notice

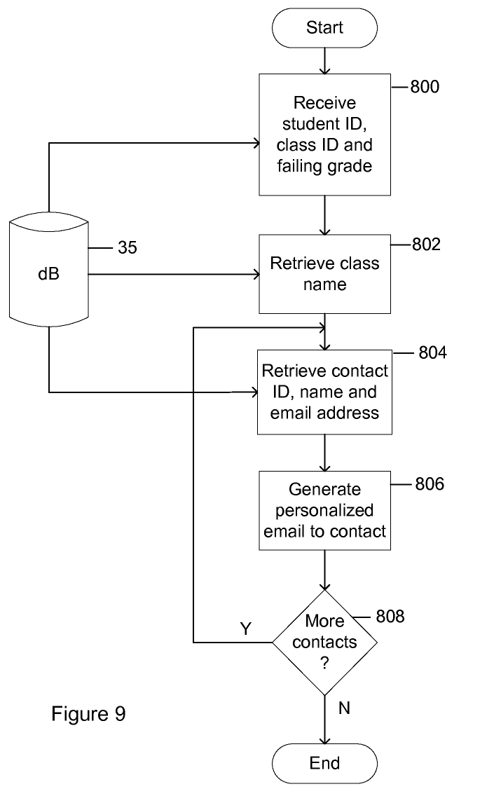

FIG. 9 illustrates the email notice process of the Safety Training and Preparedness System 20. At step 800, the system 20 accepts the student ID, class ID, and failing grade from the tests subprocess. At step 802, the system 20 retrieves the class name from the database 35, and in step 804, the system 20 retrieves the contact ID for that student from the system 20. At step 804, the system 20 also retrieves the contact name and e-mail address from the database 35. At step 806, the system 20 retrieves the e-mail notice from the database 35 and fills in the contact name, e-mail address, class name, and student name to generate a personalized email. The system 20 then sends the personalized email. At step 808, the system 20 determines whether there are any other contacts for that student. If there are, the system 20 returns to step 8-4. If not, the process ends.

### Color Coding on Displayed Reports

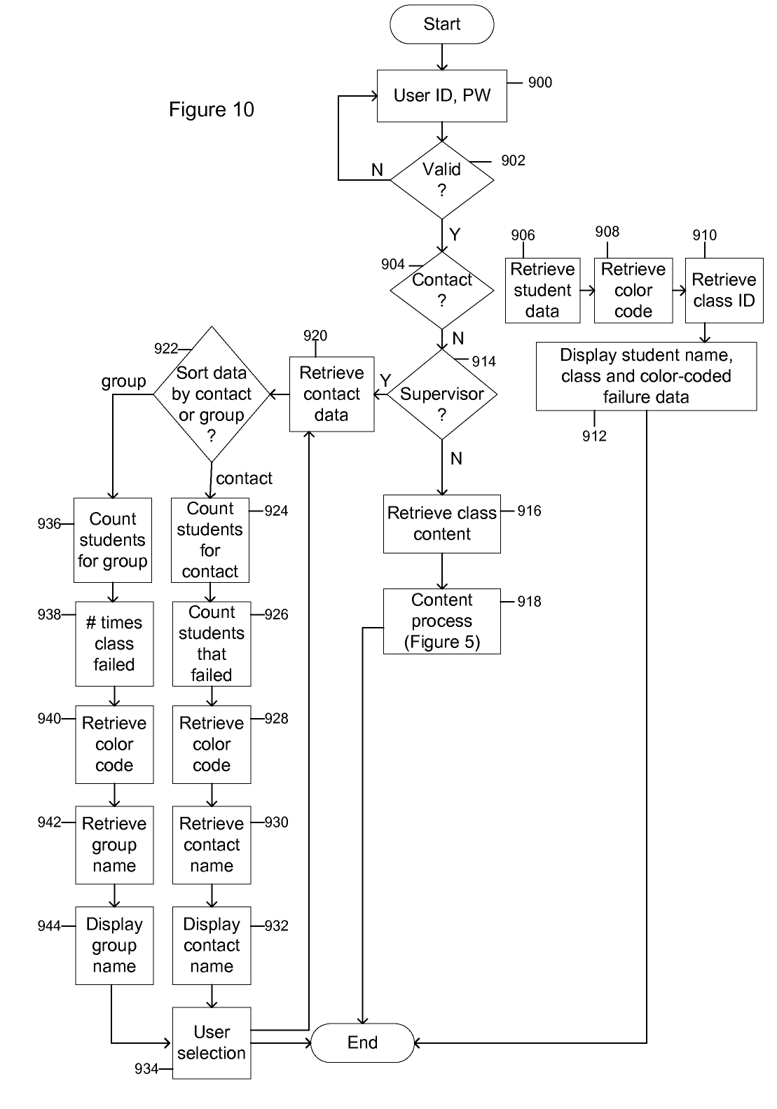

FIG. 10 illustrates the process for displaying color coded reports to contacts and supervisors in accordance with the invention. At step 900, the system 20 accepts the user ID and password and checks at step 902 whether the user ID and password is valid. If it is not, control returns to step 900. If it is valid, the system 20 proceeds to step 904 to determine whether the user a contact. If the user is a contact, the system proceeds to step 906 and retrieves the student data for the students accessible by the contact. At step 908, the system 20 retrieves the color code for the number of times failed and the actual code from database 35. The class name is retrieved from the database at step 910. At step 912, the system 20 displays the student's name, class name, and number of times failed for each class on screen. If the user is not a contact, at step 904, control proceeds to step 914 for a determination whether the user is a supervisor. If the user is not a supervisor, the system 20 proceeds to the content subprocess for students by retrieving the class content at step 916 and calling the content subprocess of FIG. 5 at step 918.

If it is determined at step 914 that the user is a supervisor, then at step 920 the system 20 retrieves the contacts the supervisor has access to from database 35. At step 922, the system 20 determines if the user wants to sort the students by contact or by group. If the user wants to sort by contact, then control passes to step 924 to count the number of students for the contact. At step 926, the system 20 counts the number of students who have failed each specific class, and at step 928 the system 20 retrieves the color code for the number of students failing and the actual code from appropriate tables of database 35. At step 930, the system 20 retrieves the contact name, and at step 932 the system 20 displays the contact name in the correct color. At step 934, the system 20 accepts the user selection of a contact's ID and proceeds to step 920. Otherwise the process ends. On the other hand, if it is determined at step 922 that the user wants to sort the students by group, then the system 20 proceeds to step 936 and counts the number of students in the group. At step 938, the number of times a class was failed by students in that group is also determined. At step 949, the system 20 retrieves the code for the color for the number of students who have failed and the code from a table of the database 35. At step 942, the system 20 retrieves the group name from database 35. The system 20 writes the color code to the group name and displays the group name with the appropriate color. At step 942, the system 20 also accepts the user input of group name and retrieves the student information from the database for the students in that group at step 944. At step 944, the color code for number of times failed, the code, and the student's name are retrieved from database 35 for display. At step 944 the name of the student in that group is displayed in the appropriate color. Once the user elects to exit, the process ends.

### Reports

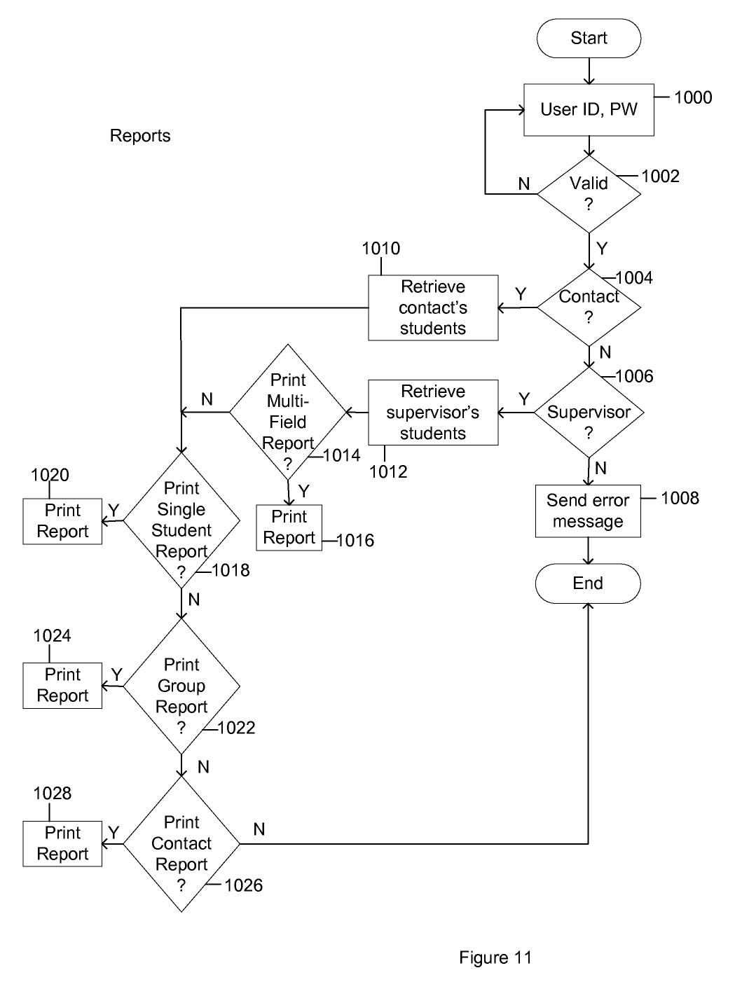

FIG. 11 illustrates the Reports subroutine of Safety Training and Preparedness System 20. At step 1000, the user ID and password is accepted and is verified at step 1002. The system 20 then determines at step 1004 if the user is a contact. If the user is not a contact, the system 20 determines at step 1006 whether the user is a supervisor. If not, the system 20 sends a system error message at step 1008 and the subroutine ends. However, if it is determined at step 1004 that the user is a contact, then at step 1010 the system 20 retrieves that contact's students from a table of the database 35. On the other hand, if it is determined at step 1006 that the user is a supervisor, the system 20 retrieves students by retrieving the contacts that the supervisor has under him and then retrieving the students for those contacts from a table of the database 35 at step 1012. It is then determined at step 1014 whether the supervisor intends to print a multi-field report (e.g., for students for different contacts) and, if so, a report is printed at step 1016. Once the students are retrieved for either the contact or the supervisor, the system 20 determines at step 1018 whether a single student report is to be printed. If so, the system 20 prints a Single Student Report at step 1020. If not, the system 20 determines at step 1022 whether to print a Percent by Group report and, if so, the system 20 prints a Percent by Group Report at step 1024. Otherwise, the system 20 determines at step 1026 whether the user wants a report by contact and, if so, the system 20 prints a Percent by Contact Report at step 1028. If not, the process ends.

An exemplary Single Student Report generated at step 1020 may contain the student's name, the class name, the pass/fail status including the number of times the student failed, and a failure percentage for the class.

On the other hand, an exemplary Percent Passing by Group Report issued at step 1024 may contain the group name, the student names and/or student IDs in that group (by contact as appropriate), passing percentage for that class, and number of times failed for those who are in that class. The system 20 also may calculate whether the students' percentages are passing or failing, as appropriate.

An exemplary Percent Passing by Contact Report issued at step 1028 may contain the contact name, the contact's students, and if the user is a supervisor, the students for the respect contacts supervised by the supervisor. The student information may include the student's name and/or ID, class ID, the number of times failed by the student, and a percentage score. The report may also include the percent passing for that class by getting the percent ID from the database 35. The system 20 may also calculate whether the students' percentages are passing or failing, as appropriate.

As exemplary Multi-Field Report issued at step 1016 identifies a specific group for which the user desires a report and retrieves the students that the contact has access to for that group. If the user is a supervisor, the system retrieves the contacts that the supervisor has access to and the students that that contact has access to. The system 20 then narrows this list by eliminating all the students from that list except for the ones that have the matching group ID. If the user desires to print a report by the specific contact, then the system 20 accepts the user input of the contact ID and retrieves the students that that contact has access to. On the other hand, if the contact ID is a supervisor, then the system 20 retrieves the contacts the supervisor has access to and the students for those contacts. The system 20 may also print reports by a specific major by allowing the user to specify a specific major ID and retrieving the students for the specified major. The printed information may include the class name, the number of times a test has been failed, a percentage that failed, the student names, and the like. The system 20 may also determine whether each student is passing or failing based on the percentages.

An automatic report may be periodically generated, such as at the end of each semester. Such a report may include attribute IDs as compared to performance evaluations for each question/content and provide this report to master statistics system 40 as described above for comparison to data from other entities. In turn, master statistics system 40 may receive automatic semester end reports from many entities for generation of an aggregated report that may be provided to system 20 and SAS 10 to help with a determination as to what the best content/question combinations are for certain student attributes. This aggregate report is preferably stored for review by faculty/personnel at each school having the system 20. The reports provide an important indicator to the faculty/personnel as to whether or not incidents have decreased for their students after the administration of the safety training modules.

### EXAMPLE

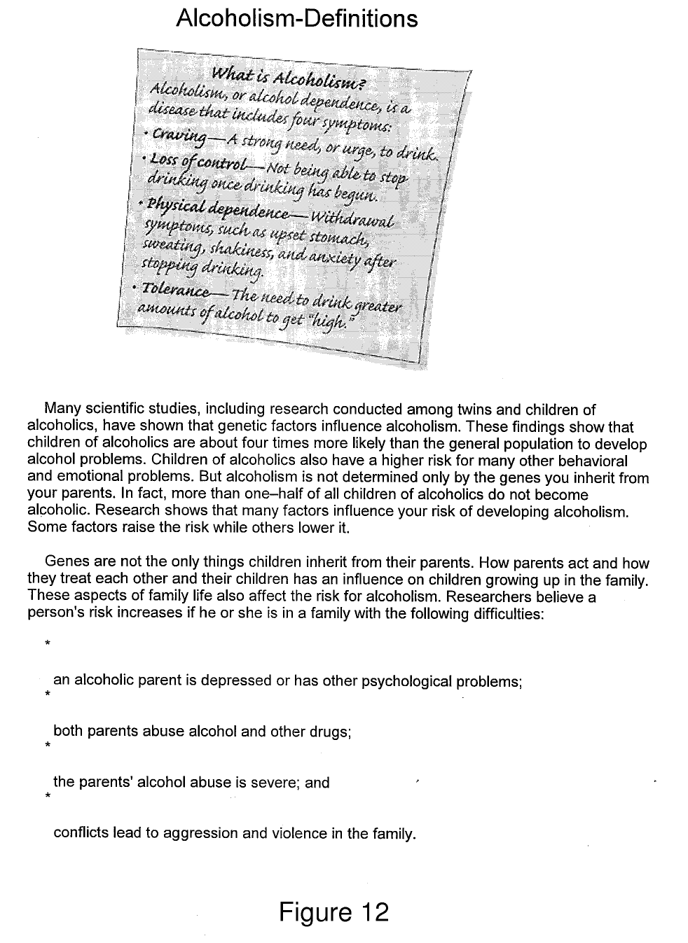

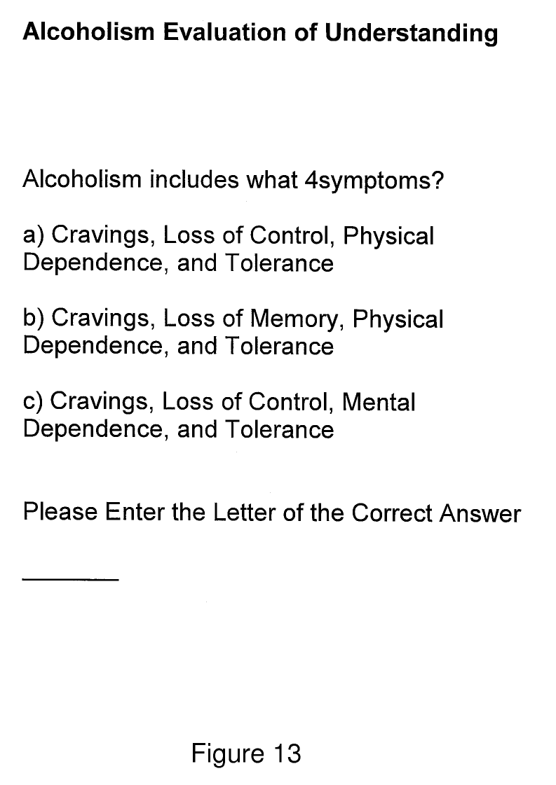

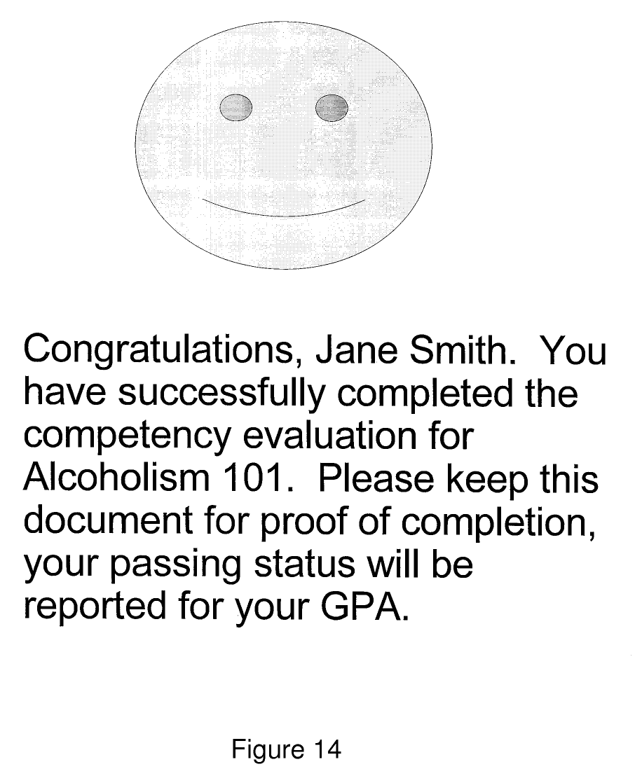

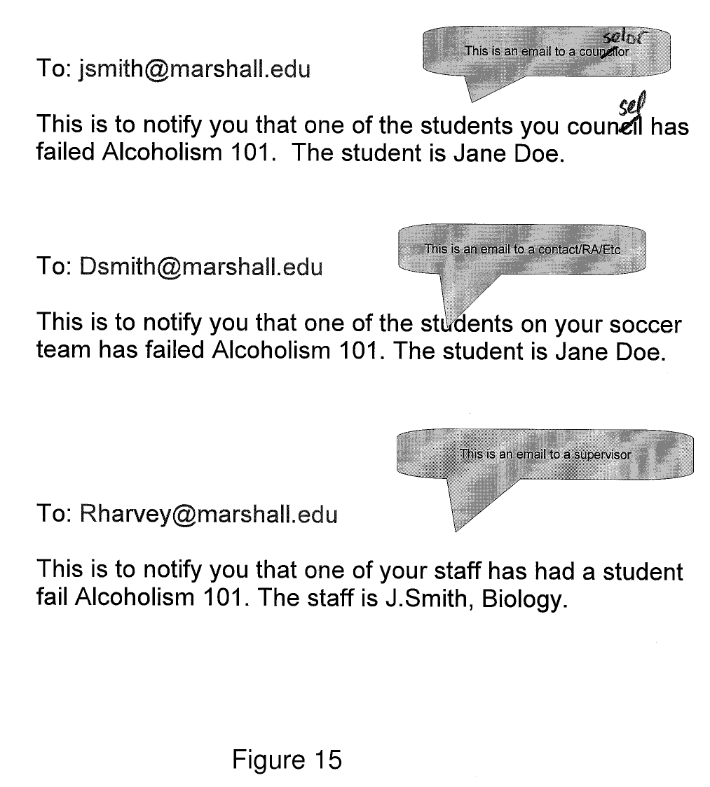

FIG. 12 illustrates sample content provided to students by the Safety Training and Preparedness System 20 for increasing student awareness of alcoholism. After a series of screens of such content are presented to the student, the student may be presented with test questions of the type illustrated in FIG. 13 for purposes of determining the student's retention of the presented information. If the student successfully passes the test by correctly answering a predetermined percentage of test questions, then a certificate is issued to the student as indicated in FIG. 14. On the other hand, if the student does not pass the predetermined percentage of test questions, then the appropriate contacts are immediately notified so that proper action may be taken. FIG. 15 illustrates sample emails forwarded to the student's counselor, coach, and coach's supervisor. Of course, other types of safety tests may be provided to the students to increase awareness of date rape, contraception, sexually transmitted diseases, drug usage, gun possession, and other potentially risky activities on campus.

The student interface to the system preferably includes a number of links for soliciting input from the student. For example, the student interface may include a link to class content for each class, a link to the test for particular content, and a link entitled “do I or my friend have a problem.” This latter link enables the student to take a test with questions about different warning signs for different problems. At the end of the test, based on a composite score, the student may be given information on how to handle their or their friend's problem and possibly told to talk to a staff person about the suspected problem. This approach may be tied in with existing screening sites such as the Lexapro depression screening web site. The link may also connect the student to additional content on symptoms and how to handle the identified problem. Additional content could also be served to the student based on the identified symptoms to better determine the extent of the student's problem.

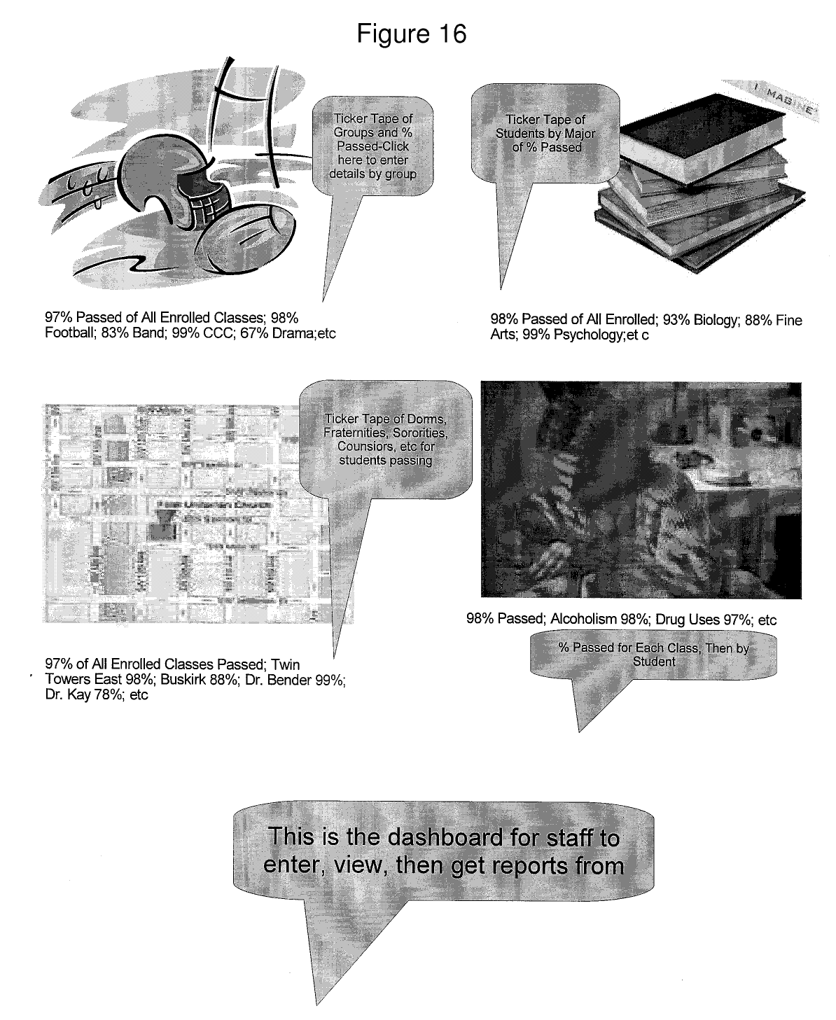

FIG. 16 illustrates a sample graphical user interface that may be presented to a staff member or supervisor to enable him/her to determine at a glance which cross-sections of the students need the most remedial help for particular safety issues. As illustrated, the students may be sorted by activity, sport, major, geographic location, membership in a fraternity or sorority, class, and the like.

The system and method of the invention may be implemented in an exemplary embodiment as software on a host computer system. The scope of the invention further includes such software stored as instructions on a computer readable medium whereby the instructions, when read off of the computer readable medium by a processor, causes the processor to implement the methodology of the invention as hearing described. Such instructions may be further organized into computer software module or means for configuring the processor to perform designated tasks. The invention described herein specifically incorporates all such embodiments.

### Variations and Other Applications

The application described herein relates to the provision of safety and health related content to students and the testing of the student's retention of such content. The system enables the test results to be closely monitored by staff at the school or university to identify the risky behaviors of the students as well as those students that are susceptible to the risky behaviors. Those skilled in the art will appreciate that the learning and evaluation system of the invention may also be used to predict risky behaviors based on certain student attributes. The questions may be customized based on the student attributes to identify those risky behaviors most prevalent among students with a particular set of attributes. For example, students may be given different test questions based on their gender, their class year, their dormitory, etc. The content and questions are designed so that over time student knowledge of risky behavior is increased and campus incidents are reduced. Those skilled in the art will further appreciate that the data collected by the invention may be extended to include on-campus crime data. In this case, the test results could be correlated with crime data and tied to student attributes and behaviors.

The system described herein may be further modified to include pseudonymized student profiling to enhance privacy as well as probabilistic determination of risk factors or adverse events before they happen. The system may also be modified to include explicit or implicit determinations (such as inference) of psychological attributes (e.g., psychographic mapping) of students and other individuals covered by the system to identify those student attributes most at risk for harmful behaviors. Data mining (including predictive data mining) techniques may be implemented in identifying correlations within the datasets captured during the testing and evaluation process. Also, the data generated by the system may be forwarded to school psychologists, campus police and other school administrators as appropriate to facilitate risk management on campus. The system also may be adapted to read in data from social networking sites to develop risk profiles for the students and to otherwise permit the evaluation and mitigation of such risk factors. Class credit and other forms of reward points may also be provided to the students to encourage their participation in the safety program described herein.

Additional applications to the school safety and security embodiment described herein may enhance the invention into a comprehensive campus safety and emergency preparedness system by incorporating such features as drug counseling (when drug problems are identified), treatments for alcohol abuse, ADHD, depression, eating disorders, and other socio-developmental factors, cyber security for protection against cyber harassment, cyber stalkers, pedophiles, ID theft, and other risks posed by the user's on-line activities, promotion of campus safety by enabling users to recognize, report and respond to campus crimes such as assaults, muggings, burglary, theft, and improper possession of weapons on campus. The system may also be adapted to identify aberrant behavior or attitudes such as chronic destructive behaviors including stealing, hate crimes, rape, date rape, sexual harassment, vandalism, hate speech or propaganda, deceptive behaviors, exploitation of others, business exploitative practices, cheating, and disrespect of authority-including disregard for rules, or chronic self-destructive behavior such as substance abuse, eating disorders, gambling addictions, self inflicted injury, and sexual addictions such as pornography. The system of the invention may also provide terrorism preparedness including enabling students to identify potential terrorist networks and activities on campus. The system of the invention also may be used to teach emergency preparedness for issues such as campus shootings, bomb threats, earthquakes, fires, and other man-made and natural disasters. Also, as noted above, the system of the invention may be extended to incorporate inputs from campus police, local governments, fire, police, and other local businesses and organizations. Importantly, the system of the invention may be used to establish a more generally accepted standard of care for students to minimize liability and to promote student safety.

The system of the invention collects data that may be useful in many ways. For example, the collected data may be mined to determine the effects of educating students, staff and administrators on the effects of awareness on overall incident prevention. Also, the incidents may be broken down by type and category of incident with correlation to the attributes of the perpetrators for development of risk profiles. The collected data may be very useful in developing remediation measures and appropriate penalties to perpetrators and negligent administrators. The data may be further correlated with rewards and penalties to determine the effects the rewards and penalties have on the number and severity of incidents. The system of the invention may also be useful in emergency (e.g., campus shooting) situations to rapidly narrow down the likely perpetrator in order to assist law enforcement and other emergency responders.

The system of the invention may be further supplemented by correlating the attributes of the students with available psychological profiles developed by police enforcement authorities to identify those student attributes fitting certain risk profiles.

The system and method of the invention is not limited to an educational setting but may also be used by public or private organizations and emergency service providers, for example, as a tool to monitor the mental and physical health and safety of their employees.

Those skilled in the art will further appreciate that the invention may be tactically implemented to provide report generator and/or email notification capabilities to contacts and/or administrators to see and/or print test results for different students by class, major geographical location and/or group in which the students are members. Those specific contacts and/or administrators to which access to such reports are provided could be used to establish a chain of custody of accountability and responsibility for each contact and/or administrator for which certain responsibilities are required of that contact or administrator such as certain minimum standards criteria (e.g, that each student under his/her responsibility participates in the online learning and evaluation system, that the failure rate is small or non-existent and/or that all “high risk” students are provided the necessary additional remedial content or other means of mitigating the inherent risks as described in the present specification).

These and other such modifications are believed to be within the scope of the present invention as identified by the followings claims.

What is claimed:

1. An on-line learning and evaluation system for an entity that is responsible for educating students, comprising:
means for providing learning materials to students and for testing the students on their comprehension of the learning materials;
means for reporting test results to designated student contacts and/or administrators of the entity; and
statistical analysis processing means for analyzing the test results in combination with student attributes representative of the students' characteristics to determine if the content of the learning materials and/or test materials should be changed to achieve a greatest level of proficiency of understanding for the provided learning materials.

2. The system of claim 1, wherein the entity comprises an educational institution, an emergency service provider, a public organization, and/or a private organization.

3. The system of claim 1, wherein the learning materials relate to student safety and/or sociological and/or psychometric risk factors of the students and the test results reported to the designated contacts and/or administrators enable the contacts and/or administrators to identify student attributes that put students with such attributes at potential risk to themselves or others and/or to identify students that need additional learning materials and/or professional help.

4. The system of claim 3, wherein the learning materials are adapted to train the students in how to respond to situations that impact their or other's safety and/or to identify risk factors in themselves or others that could potentially become a safety risk.

5. The system of claim 1, wherein the statistical analysis processing means correlates the content of the learning materials and/or test materials with performance statistics of individuals and/or groups or users sharing a common user attribute.

6. The system of claim 1, wherein the reporting means includes an email generator that generates customized emails to a student's designated contacts and/or administrators when the student fails a test or a particular section of a test.

7. The system of claim 1, wherein the statistical analysis processing means changes test questions and/or learning materials provided to particular students and/or groups of students based on a correlation of student test results with said student attributes.

8. The system of claim 1, further comprising a master statistics server that receives reports from said entity and other entities having said system, said master statistics server programmed to aggregate the reports from each entity and to provide an aggregated report to those entities requesting the aggregated report.

9. The system of claim 1, wherein the means for reporting test results further comprises means for providing the designated student contacts and/or administrators of the entity with information providing insight into reasons for a student's failure to comprehend certain of said learning materials or failure to mitigate certain attributes that define high risk students once the student has been tested on the learning materials.

10. A computer-implemented method for an entity to provide on-line learning and evaluation of students associated with said entity, comprising:
the computer providing learning materials to students and testing the students on their comprehension of the learning materials;
the computer reporting test results to designated student contacts and/or administrators of the entity; and
the computer statistically analyzing the test results in combination with student attributes representative of the students' characteristics to determine if the content of the learning materials and/or test materials should be changed to achieve a greatest level of proficiency of understanding for the provided learning materials.

11. The method of claim 10, wherein the entity comprises an educational institution, an emergency service provider, a public organization, and/or a private organization.

12. The method of claim 10, wherein the learning materials relate to student safety and/or sociological and/or psychometric risk factors of the students, and wherein the test results reported to the designated contacts and/or administrators are used by the contacts and/or administrators to identify student attributes that put students with such attributes at potential risk to themselves or others and/or to identify students that need additional learning materials and/or professional help.

13. The method of claim 12, wherein the learning materials are adapted to train the students in how to respond to situations that impact their or other's safety and/or to identify risk factors in themselves or others that could potentially become a safety risk.

14. The method of claim 10, wherein the statistically analyzing step comprises the computer correlating the content of the learning materials and/or test materials with performance statistics of individuals and/or groups or users sharing a common user attribute.

15. The method of claim 14, further comprising the step of the computer changing test questions and/or learning materials provided to particular students and/or groups of students based on the correlation of student test results with said student attributes.

16. The method of claim 10, wherein the reporting step comprises the computer generating customized emails to a student's designated contacts and/or administrators when the student fails a test or a particular section of a test.

17. The method of claim 10, further comprising the step of the computer providing a report from said entity to a master statistics server that receives reports from said entity and other entities implementing said method, and the computer receiving an aggregated report of reports from said other entities implementing said method.

18. The method of claim 10, wherein the reporting step further comprises the step of the computer providing the designated student contacts and/or administrators of the entity with information providing insight into reasons for a student's failure to comprehend certain of said learning materials or failure to mitigate certain attributes that define high risk students once the student has been tested on the learning materials.

19. A computer readable medium having instructions stored thereon that when processed by a processor cause said processor to implement a method by which an entity may provide on-line learning and evaluation of students associated with said entity, said computer readable medium comprising instructions for performing the steps of:
providing learning materials to students and testing the students on their comprehension of the learning materials;
reporting test results to designated student contacts and/or administrators of the entity; and
statistically analyzing the test results in combination with student attributes representative of the students' characteristics to determine if the content of the learning materials and/or test materials should be changed to achieve a greatest level of proficiency of understanding for the provided learning materials.

20. The computer readable medium of claim 10, wherein the learning materials relate to student safety and/or sociological and/or psychometric risk factors of the students, and wherein the test results reported to the designated contacts and/or administrators are used by the contacts and/or administrators to identify student attributes that put students with such attributes at potential risk to themselves or others and/or to identify students that need additional learning materials and/or professional help.

21. The computer readable medium of claim 20, wherein the learning materials are adapted to train the students in how to respond to situations that impact their or other's safety and/or to identify risk factors in themselves or others that could potentially become a safety risk.

22. The computer readable medium of claim 19, wherein the statistically analyzing step comprises correlating the content of the learning materials and/or test materials with performance statistics of individuals and/or groups or users sharing a common user attribute.

23. The computer readable medium of claim 22, further including instructions for implementing the step of changing test questions and/or learning materials provided to particular students and/or groups of students based on the correlation of student test results with said student attributes.

24. The computer readable medium of claim 19, wherein the reporting step comprises generating customized emails to a student's designated contacts and/or administrators when the student fails a test or a particular section of a test.

25. The computer readable medium of claim 19, further comprising instructions for implementing the step of providing a report from said entity to a master statistics server that receives reports from said entity and other entities implementing said method, and receiving an aggregated report of reports from said other entities implementing said method.

26. The computer readable medium of claim 19, further comprising instructions for providing the designated student contacts and/or administrators of the entity with information providing insight into reasons for a student's failure to comprehend certain of said learning materials or failure to mitigate certain attributes that define high risk students once the student has been tested on the learning materials.
